(19) United States
(12) Patent Application Publication
(10) Pub. No.: US 2010/0215829 A1
(43) Pub. Date: Aug. 26, 2010

(54) APPARATUS AND METHOD FOR MIXING COMPONENTS

(75) Inventor: HANS HOOGLAND, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/773,872

(22) Filed: May 5, 2010

Related U.S. Application Data
(62) Division of application No. 10/568,562, filed on Feb. 17, 2006.

(30) Foreign Application Priority Data
Aug. 21, 2003 (EP) 03077612.4

(51) Int. Cl. A23D 9/02; A23L 1/24

(52) U.S. Cl. 426/589; 426/602; 426/605

(57) ABSTRACT

The invention relates to an apparatus suitable for preparing a variety of emulsion type of food products. The apparatus omprises a source unit (a) for components that are used to make a base product and a source unit (b) for post-added ingredients. It

### FIELD OF THE INVENTION

The invention relates to an apparatus for mixing components for the preparation of emulsion type food products.

### BACKGROUND OF THE INVENTION

Dressings, spreads, sauces and other oil and water emulsion based products are well known. Over the years the number of different variants that is available for such emulsions has grown. When made at home, consumers can make their personal dressing or sauce variant and add the desired ingredients to match their liking. There is also a trend in society to obtain a ready meal or parts of the meal from a restaurant or store without the need to do any cooking activity yourself. It is evident that the variety provided via a restaurant, store or other retail outlet is limited because of the amount of time it takes to make personalized emulsion type products. Also the amount of product purchased if a large variety is offered is very low, and often too low to justify the preparation of each particular variant.

U.S. Pat. No. 6,280,075 discloses a plant for continuously preparing at least two different liquid foodstuff mixtures. This document addresses the problem that for the preparation of a variety of beverages in a factory, plant portions which treat basically mixture components, e.g. in case of beverages water and sugar solution, must be present two fold or in a plurality of numbers, causing correspondingly high procurement and operating costs. According to U.S. '075 this problem is solved by a plant system in which only one single plant portion is needed for the

Furthermore the size of this dispensing unit, which is manually operated, is not enabling efficient preparation of individually adapted emulsion type products instantaneously for example in a fast food service restaurant.

U.S. Pat. No. 5,230,443 addresses the need for a reliable, relatively inexpensive apparatus and method for dispensing a variety of condiments through a single dispensing unit in a metered quantity and at a low flow rate. Providing a device, which comprises a pump, which is fluidly connected to a condiment source and a dispensing apparatus, solves this need. Multiple pumps (e.g. 3) may be included wherein each pump is connected to a different condiment source. This enables independent dispensing of e.g. 3 different types of condiment. Again this offers only limited variety and requires a separate condiment source for each type of condiment offered. Also the products obtained from this device are not fresh products.

One of the known problems associated with apparatus' that provide a variety of products with different recipes is cross contamination between products that are of different composition but dispensed through the same nozzle. U.S. Pat. No. 4,753,370 discloses a mixing nozzle that can mix different flavours into a product stream, without cross contamination. This is achieved by mixing the flavour in-line into a flowing aqueous stream wherein the flavour is injected such that the flavour dos not touch any of the nozzle housing. This solution may be suitable for low viscosity beverages wherein homogeneous mixing is relatively easy but was found to be unsuitable for homogeneously mixing oil and water compositions which are more viscous. Generally oil and water emulsions are either pourable or spoonable and the higher the visocity, the more cross contamination may be occurring.
selection means for selecting the desired post-added ingredients;
processing means (2) suitable for mixing the components from the component reservoirs and the post-added ingredients;
a dispensing unit (7) for dispensing the resulting oil and water emulsion,
   wherein the configuration of the apparatus is such that changes in recipe of the oil and water emulsion do not require intermediate cleaning of the apparatus.

In another aspect the invention relates to an apparatus for preparing and dispensing an oil and water containing emulsion comprising one or more post-added ingredients, the apparatus comprising a frame comprising
a source unit (a) comprising one or more component reservoirs (1);
selection means for selecting the desired components and/or their ratio
a source unit (b) for post-added ingredients (b1) wherein the post-added ingredients are arranged in at least two families;
selection means for selecting the desired post-added ingredients;
processing means (2) comprising mixing means suitable for mixing the components from the component reservoirs and the post-added ingredients;
a dispensing unit (7) for dispensing the resulting oil and water emulsion,

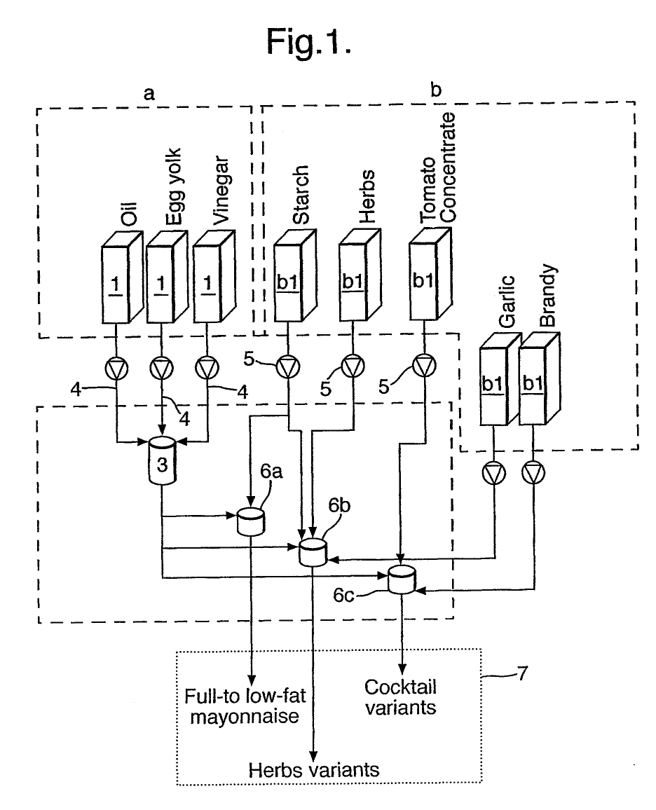

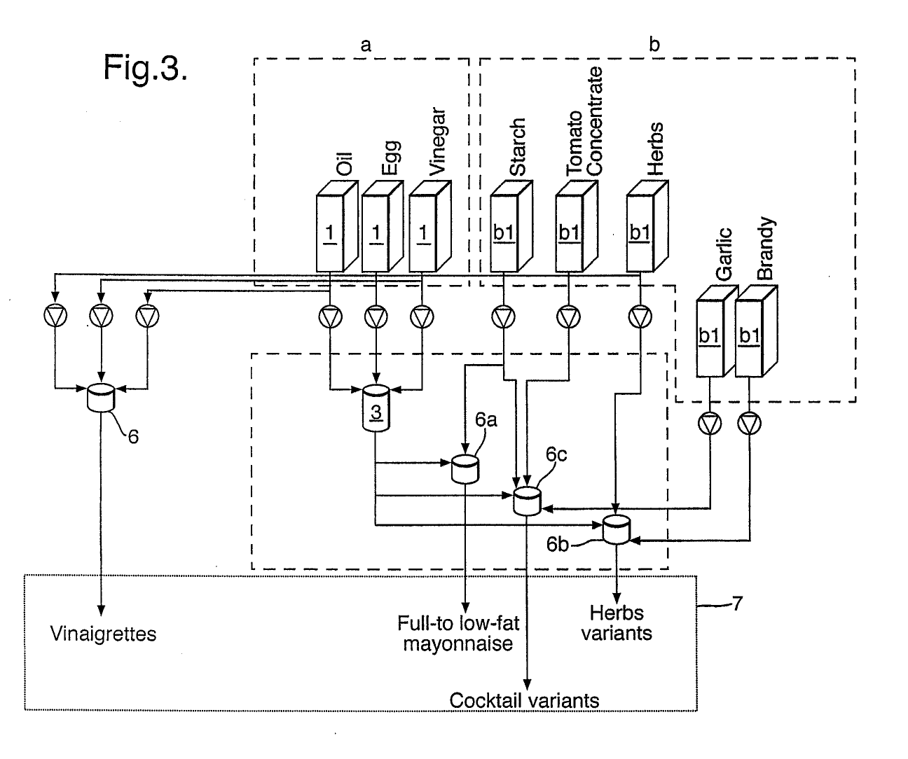

FIGS. 1, 2 and 3 show schematic embodiments of the apparatus according to the invention.

Before giving a detailed description of the figures, the following is noted. In FIGS. 1,2 and 3 a preferred embodiment of the apparatus according to the invention is shown. Only parts of the apparatus essential for understanding the invention have been illustrated. It will be appreciated that the apparatus will further comprise the general means for making it function such as pumps, lines/conduits, valves, control panels, electricity inlet and the like.

The apparatus is adapted for use by consumers, as opposed to use in a factory. In the context of the invention the term consumer refers to an individual person who is either end consumer or e.g. assistant in a shop or restaurant and who operates the apparatus. For some applications the apparatus may offer a relatively high throughput in the range of up to thousands of kilograms per hour.

The apparatus functions in a batch mode contrary to the known continuous preparation in factories. The apparatus is suitable for use in a batch process and for dispensing only one product at a time.

The apparatus comprises a frame or housing which comprises most elements, preferably all elements. Optionally some of the reservoirs may be placed outside the housing, depending e.g. on their size. Placing some of the reservoirs outside the housing may also make them more easy to handle for refilling and/or changing.

more reservoirs that are part of the source unit (a) are placed outside the apparatus.

The apparatus is provided with selection means to enable the selection of a particular ingredient, base product or combination thereof from the reservoirs in source unit (a). In addition thereto the selection means may be such that it enables the selection of a ratio of volumes of the particular ingredient or base product. Alternatively the volumes are set volumes which can not be individually adapted. Preferably the apparatus comprises an interface which enables a consumer to select one or more end products for production.

The reservoirs are connected to a processing means (2). The processing means comprises an inlet for components originating from the reservoirs (1) and for post-added ingredients. The processing means should be suitable for mixing the ingredients originating from the reservoirs in source unit (a) and the post-added ingredients. It is therefore preferred that the processing means is a mixer such as a static mixer or a dynamic mixer, or a series of mixers. Although the use of one or more mixers is preferred to obtain homogeneous end products, optionally mixers are eliminated. The elimination of the mixer may be used to provide special effects e.g. red tomato striping on mayonnaise.

Optionally the processing means is provided with a heating or cooling element, a shear device such as a homogeniser, or an ultrasound generator. Examples of a suitable heating element are a microwave generating unit, inductive heating element and an ohmic heating element. The ultrasound generator may e.g. be used for emulsification or solubilisation.

Post-added ingredients are defined as ingredients that can be added to a base product to differentiate it and which preferably require little or no shear to be included in the products.

Each family of post-added ingredients is composed of at least 1 ingredient, preferably at least 2 ingredients, more preferred from 3 to 10 ingredients. Each family of post-added ingredients is composed such that each member thereof is highly similar in colour, taste and consistency such that little residue that may remain in the mixer will not have an adverse effect on the perception of the product by the end-user.

As indicated above, one of the main problems known from the art is cross-contamination between subsequent products. This problem is especially present for relatively viscous products such as products which are pourable or spoonable. Pourable products suitably will have a viscosity in the range of 0.1 to 40 dPa.s (deci-Pascal.s) when measured with a Haake viscosimeter type VT02, measured with head No.3, in measure beaker with 5 cm diameter at a temperature of 5 or 10° C., measured after a few seconds when value is about constant, rotation speed being 62.5 rotations per minute (rpm). The measurement is to be carried out 3 days after preparation of the emulsion and storage at 5° C.

In such cases the cross contamination may arise due to back mixing. This problem is less apparent in non-viscous fluids such as water and soft drink beverages.

Most preferred a consumer would not notice cross contamination with previously made product. Although it is possible to mix all post-added ingredients with the components from the reservoirs of source unit (a) in one mixer, it is highly and type and amount of post-added ingredients on the other hand.

The apparatus further comprises a dispensing unit (7). The dispensing unit is positioned after the last mixer that is part of the processing means (2). To minimise the volume of the previous product in a subsequent product having a different recipe, the volume of the conduits between the last mixer of the processing means (2) and dispenser(7) is preferably as small as possible. It is preferred that the volume of the conduits between the last mixer, which is usually the mixer used for mixing post-added ingredients, and the dispensing unit is less than 20 vol %, more preferred less than 10 vol %, most preferred less than 5 vol % of the dispensing volume.

Furthermore, in all embodiments of the invention, the volume of the mixing means is preferably small in comparison to the volume of the product to be dosed. E.g. a ratio of from 1 volume unit for the mixer to at least 5 volume units for the dosed product, preferably 5-100 volume units, more preferred 10. to 40 volume units for the dosed product was found suitable. The small volume of the post-mixer in comparison to the next product dose is believed to have the following benefit. When the customer changes the recipe, only a small part of the next dose will contain the previous product. This allows to feed more post-added ingredients through the same post-mixer.

The apparatus according to the invention may be operated manually but it is preferred to have it controlled automatically e.g. via a computer with touch screen or a PLC or other alternative electronic devices. Preferably the pumps are electrically driven and controlled.

The apparatus according to the invention may be provided with means for cooling and/or heating the reservoirs for example a chilled reservoir to keep egg-yolk or another phase stable for a longer period. Optionally the apparatus comprises an electrically heated reservoir to give fats/oils a lower viscosity.

Thus, the circumstances for preparing the product may be controlled temperature-wise.

Optionally the product is directly dispensed on a plate to be combined with other food or directly on a final food preparation.

It is preferred that the main components of the apparatus are made of a suitable, easy to clean material. Examples of suitable material are stainless steel, plastics. The tubes are preferably made of material compatible with the ingredients, e.g. neoprene, silicone, viton etc.

For the preparation of dressings it is most preferred that the reservoirs comprise at least an oil phase, vinegar and egg yolk. Optional post-added ingredients are herbs, starch, garlic, and tomato concentrate such as ketchup.

For the preparation of sauces the reservoirs in source unit (a) preferably comprise an oil phase and an aqueous phase. Optional post-added ingredients are starch, thickener, herbs, spices, vegetable (pieces), colorant, preservatives.

Optionally the oil phase is replaced by another structuring phase such as a tomato or avocado base which derive their structuring capability from the presence of plant fibres. means to make an emulsion e.g. by electric fields, ultra-sound etc.

The reservoirs are connected to the pre-mixer via tubes (4).

In a preferred embodiment the reservoirs are connected to the pre-mixer unit via positive displacement pumps. These pumps enable accurate dosing of ingredients into the pre-mixer unit.

The post-added ingredients are stored in reservoirs (b1) in source unit (b). They are preferably mixed into the emulsion created in the pre-mixer via a mixing unit (6). Although the use of post-mixers is preferred to obtain homogeneous end products, optionally they are eliminated. The elimination of the post-mixers may be used to provide special effects e.g. red striped products.

According to another embodiment, part of the post-added ingredients are added by in-line addition which eliminates the need for dedicated mixers. This in-line addition may for examples be used for the addition of certain flavour concentrates.

To avoid cross-contamination of the different variants that pay be dispensed, the processing means preferably comprises a dedicated mixer (6) for each family of post-added ingredients.

In use a consumer will obtain a container which is placed beneath the dispensing unit (7). The consumer chooses the type of product, amount and variety by pressing buttons on a control panel.

Hence the apparatus according to FIG. 1 is suitable for dispensing a variety of products that can be selected by a consumer without the need for extensive cleaning operations when there is a product switch.

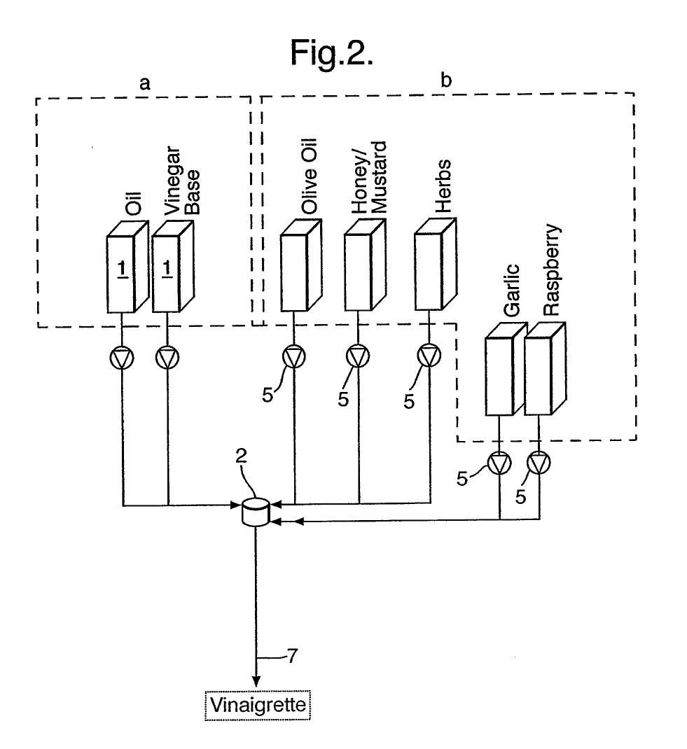

In FIG. 2 an apparatus according to the invention is shown for preparing vinaigrette.

In this embodiment, the source unit (a) comprises two reservoirs; one for an oil phase, one for an aqueous phase. The preferred aqueous phase is vinegar for these products. In operation, from 30 to 80 wt % oil phase and from 20 to 70 wt % aqueous phase are pumped to mixing unit (6). To this mixing unit, post-added ingredients are added. The preferred post-added ingredients that are selected via the selection means are one or more from the family of herbs, one or more from the family of oils and one or more from honey and mustard and one or more from a flavour concentrate such as raspberry concentrate. In processing means(2) all ingredients are blended in a mixer and subsequently the resulting vinaigrette is dispensed via dispensing unit (7). By selecting only olive oils for addition to the blend of oil and vinegar, a classical vinaigrette may be prepared. The selection of a combination of herbs and garlic concentrate enables the formation of herb and garlic vinaigrette. The selection of addition of honey/mustard to the blend of oil and vinegar, a honey/mustard vinaigrette is prepared. The mere addition of raspberry flavour to the blend of oil and vinegar in mixer (6) leads to formation of a raspberry vinegraitte.

1-9. (canceled)

10. A method of preparing a water and oil emulsion type food product, using an apparatus comprising a frame, said apparatus further comprising:
a source unit (a) comprising one or more component reservoirs (1);
selection means for selecting the desired components and/or their ratio;
a source unit (b) for post-added ingredients (b1) wherein the post-added ingredients are arranged in at least two families;
selection means for selecting the desired post-added ingredients;
processing means (2) comprising mixing means suitable for mixing the components from the component reservoirs and the post-added ingredients;
a dispensing unit (7) for dispensing the resulting oil and water emulsion,
wherein the ratio of the volume of the product that is dispensed to the volume of the mixing means is at least 5:1; and
wherein in said method the components of an oil phase reservoir, aqueous phase reservoir and emulsifier reservoir are mixed in a pre-mixer (3) to obtain an emulsion;
followed by addition of the post-added ingredients (b1) via dedicated mixers (6) for each family of post-added ingredients.

11. The method according to claim 10 wherein the food product is a dressing and the source unit (a) comprises separate reservoirs (1) that are provided with an oil phase, an aqueous phase having a pH below 3.8 and an emulsifier, wherein said oil phase, aqueous phase and emulsifier are pumped to a pre-mixer creating an emulsion, followed by addition of post-added ingredients (b1) selected from the family of herbs, the family of colorants and the family of flavourings via dedicated post-mixers to form the dressing, and dispensing the dressing.

12. The method according to claim 10, wherein the families of ingredients are selected from the group consisting of flavouring agents, structuring agent, herbs and colourants.

13. The method according to claim 10, wherein the source unit (a) comprises separate reservoirs (1) for a composition selected from the group consisting of an oil phase, an aqueous phase, emulsifier, tomato base, mustard, mayonnaise base, dressing base and sauce base.

14. The method according to claim 10, wherein each family of post-added ingredients is composed such that each member thereof is highly similar in colour, taste and consistency such that any residue which may remain in the processing means will not have an adverse effect on the perception of the product by the end-user.

15. The method according to claim 10, wherein the dispensing unit (7) is suitable for use in a batch process and dispensing only one product at a time.

16. A method for a consumer preparing and dispensing an oil and water containing emulsion comprising one or more post-added ingredients using an apparatus comprising a frame, said apparatus further comprising
a source unit (a) comprising one or more component reservoirs (1);
selection means for selecting the desired components and/or their ratio;
a source unit (b) for post-added ingredients (b1) wherein the post-added ingredients are arranged in at least two families;
selection means for selecting the desired post-added ingredients;
processing means (2) comprising mixing means suitable for mixing the components from the component reservoirs and the post-added ingredients;
a dispensing unit (7) for dispensing the resulting oil and water emulsion,
said method comprising the steps of:
(i) the consumer placing a container beneath the dispensing unit (7);
(ii) the consumer choosing the type of product, amount and variety;
(iii) the mixing means mixing the components and the post added ingredients; and
(iv) the dispensing unit dispensing the resulting oil and water emulsion into the container;
wherein the volume ratio of the volume of the product that is dispensed to that of the mixing means is at least 5:1.

17. The method according to claim 1, wherein the dispensing unit (7) is suitable for use in a batch process and dispensing only one product at a time.

18. The method according to claim 1, wherein the processing means (2) comprises a pre-mixer unit (3) suitable for creating an oil and water emulsion.

19. The method according to claim 1, wherein the apparatus comprises a dedicated mixer (6) for each family of post-added ingredients (b1).

20. The method according to claim 1, wherein the apparatus is sited in a shop or restaurant.
